(19) United States
(12) Patent Application Publication
(10) Pub. No.: US 2013/0021326 A1
(43) Pub. Date: Jan. 24, 2013

(54) LED DRIVING SYSTEM AND DISPLAY DEVICE USING THE SAME

(71) Applicants: CHENG-HUNG TSAI, Jhongli City (TW); CHIN-PO CHENG, Jhongli City (TW)

(72) Inventors: CHENG-HUNG TSAI, Jhongli City (TW); CHIN-PO CHENG, Jhongli City (TW)

(73) Assignee: AMPOWER TECHNOLOGY CO., LTD., Jhongli City (TW)

(21) Appl. No.: 13/308,556

(22) Filed: Dec. 1, 2011

(30) Foreign Application Priority Data
Jul. 18, 2011 (TW) 100125286

(51) Int. Cl. G06T 15/00; G06F 3/038; G09G 3/32; G09G 5/00

(52) U.S. Cl. 345/419; 345/211; 345/82

(57) ABSTRACT

A light emitting diode (LED) driving system driving a LED array of a display device includes a microcontroller, a control circuit, a pulse width modulator (PWM) controller, a first driving circuit, a second driving circuit, a first converter circuit and a second converter circuit. The microcontroller outputs a first signal when the display device is in a three dimension (3D) mode. The control circuit generates and output a 3D control signal upon receiving the first signal. The second converter circuit converts a direct current power into a second direct current voltage when the display device is in the 3D mode, and the second converter circuit stops working when the display device is in a two dimension mode.

### BACKGROUND

1. Technical Field

The disclosure relates to display devices, and particularly to a light emitting diode driving system of a display device.

2. Description of Related Art

Three dimension (3D) light emitting diode (LED) televisions (TV) are becoming popular. Because the LED TV in a 3D mode needs higher brightness than that in a two dimension (2D) mode, LEDs, backlights of the LED TV, require much more current and voltage in the 3D mode than in the 2D mode. In other words, load characteristics of the LED driving system are different in the 2D mode and the 3D mode, which causes difficulty in choosing elements of the LED driving system.

### BRIEF DESCRIPTION OF THE DRAWINGS

FIG. 1 is a schematic diagram of one embodiment of a display device as disclosed.

FIG. 2 is a schematic diagram of one embodiment of a LED driving system as disclosed.

FIG. 3 is a circuit diagram of one embodiment of a LED driving system as disclosed.

### DETAILED DESCRIPTION

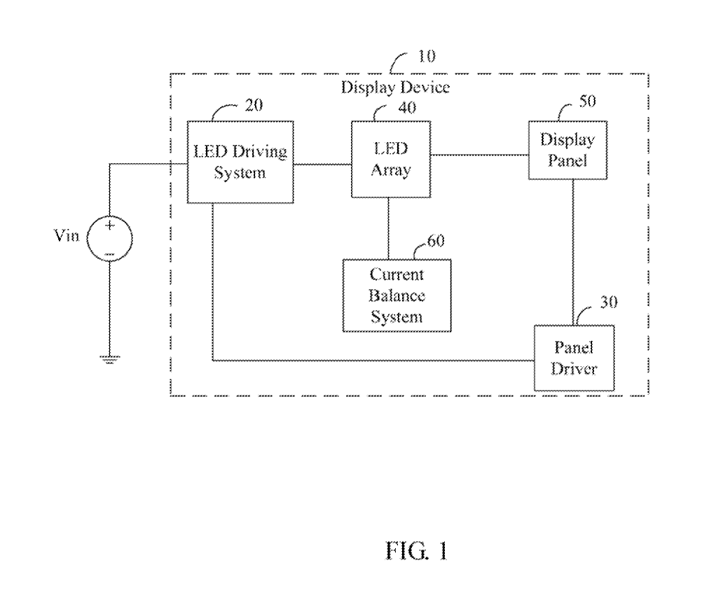

FIG. 1 is a schematic diagram of one embodiment of a display device 10 as disclosed. In the embodiment, the display device 10 comprises a light emitting diode (LED) driving system 20, a panel driver 30, a LED array 40, a display panel 50, and a current balance system 60. In the embodiment, an anode of the LED array 40 is an anode of the first LED of the LED strings, and a cathode of the LED array 40 is a cathode of the last LED of the LED strings. The display device 10 is configured to display either in a two dimension (2D) mode or in a three dimension (3D) mode. The panel driver 30 drives the display panel 50 to display video content in the 2D mode or the 3D mode, generates a first logic notification signal, such as logic low voltage signal (0), to the LED driving system 20 when the display panel 50 is in the 2D mode, and generates a second logic notification signal, such as logic high voltage signal (1), to the LED driving system 20 when the display panel 50 is in the 3D mode.

The LED driving system 20 converts direct current power Vin into voltage suitable to drive the LED array 40 to light the display panel 50, and adjusts the voltage output to the LED array 40 according to the first or second logic notification signal to adjust brightness of the LED array 40 to satisfy different brightness needs of the display panel 50. The current balance system 60 is connected to the cathode of the LED array 40 to balance current flowing through the LED array 40. In the embodiment, the LED driving system 20 receives the second logic notification signal, such as the logic high voltage signal, and subsequently outputs high voltage, such as 5V, to the LED array 40 to increase the brightness of the LED array 40 when the display panel 50 is in the 3D mode. The LED driving system 20 receives the first logic notification signal, such as the logic low voltage signal, and subsequently outputs low voltage, such as 2V, to the LED array 40 to lower the brightness of the LED array 40 when the display panel 50 is in the 2D mode.

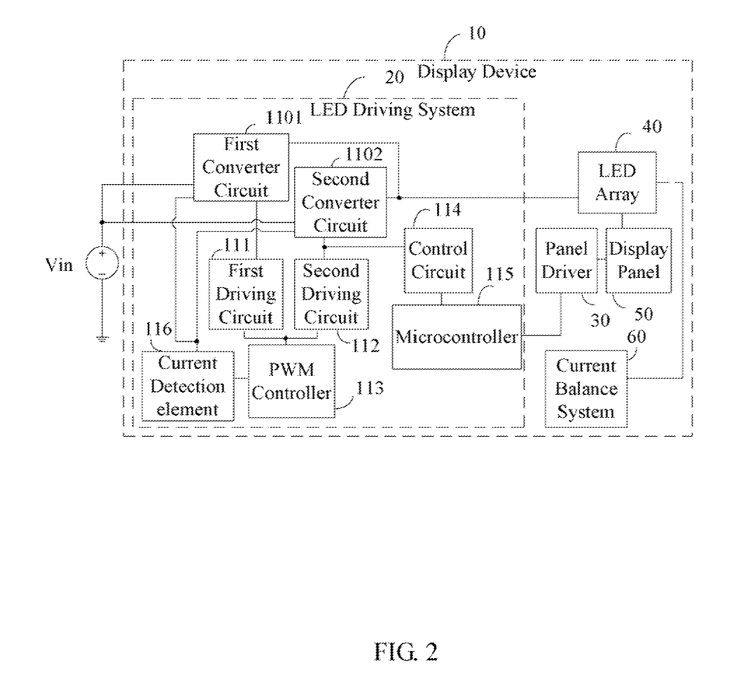

FIG. 2 is a schematic diagram of one embodiment of the LED driving system 20. In the embodiment, the LED driving system 20 comprises a first converter circuit 1101, a second converter circuit 1102, a first driving circuit 111, a second driving circuit 112, a pulse width modulator (PWM) controller 113, a control circuit 114, a microcontroller 115 and a current detection element 116. The panel driver 30 drives the display panel 50 to display the video content in the 2D mode or in the 3D mode selectively, and generates different notification signals according to the display device 10 being in the 2D mode or the 3D mode. The microcontroller 115 is connected to the panel driver 30 to receive the notification signals, and either outputs a first signal when the notification signal is the second logic notification signal, or outputs a second signal when the notification signal is the first logic notification signal. The first signal is a 3D micro-control signal, and the second signal is a 2D micro-control signal. In the embodiment, for example, the 3D micro-control signal is logic 0, and the 2D micro-control signal is logic 1. In another embodiment, the 3D micro-control signal is logic 1, and the 2D micro-control signal is logic 0.

The control circuit 114 is connected to the microcontroller 115 to generate a 3D control signal to the second converter circuit 1102 upon receiving the 3D micro-control signal, and to generate a 2D control signal to the second converter circuit 1102 upon receiving the 2D micro-control signal. In the embodiment, for example, the 3D control signal is logic 1 upon the 3D micro-control signal is logic 0, and the 2D control signal is logic 0 upon the 2D micro-control signal is logic 1. In another embodiment, the 3D control signal is logic 0 upon the 3D micro-control signal is logic 1, and the 2D control signal is logic 1 upon the 2D micro-control signal is logic 0. That is, the 3D control signal has opposite voltage level to the 3D micro-control signal, and the 2D control signal has opposite voltage level to the 2D micro-control signal. The first driving circuit 111 generates a first driving signal according to a PWM control signal generated by the PWM controller 113. The second driving circuit 112 generates a second driving signal according to the PWM control signal.

The first converter circuit 1101 is connected to the direct current power Vin and the first driving circuit 111, to convert the direct current power Vin into a first direct current voltage to drive the LED array 40 according to the first driving signal. The second converter circuit 1102 is connected to the direct current power Vin, the second driving circuit 112 and the control circuit 114, to convert the direct current power Vin into a second direct current voltage to drive the LED array 40 according to the second driving signal. In the embodiment, the control circuit 114 outputs the 3D control signal, and the second converter circuit 1102 converts the direct current power Vin into the second direct current voltage upon receiving the second driving signal when the display panel 50 is in the 3D mode. In the 2D mode of the display panel 50, the control circuit 114 outputs the 2D control signal, which causes the second driving signal to cut off, and the second converter circuit 1102 stops converting the direct current power Vin into the second direct current voltage upon not receiving the second driving signal. The current detection element 116 is connected to the first converter circuit 1101, the second converter circuit 1102 and the PWM controller 113 and detects total current of the first converter circuit 1101 and the second converter circuit 1102, and then outputs a feedback signal to the PWM controller 113 according to the total current. Correspondingly, the PWM controller 113 adjusts duty cycle of the PWM signal according to the feedback signal.

In the embodiment, upon receiving the second logic notification signal, the microcontroller 115 outputs the 3D micro-control signal to the control circuit 114. Correspondingly, the control circuit 114 outputs the 3D control signal to the second converter circuit 1102. In response to the 3D control signal, the second converter circuit 1102 receivers the second driving signal, and correspondingly converts the direct current power Vin into the second direct current voltage when the display device is in the 3D mode. The first converter circuit 1101 converts the direct current power Vin into the first direct current voltage according to the first driving signal generated by the first driving circuit 111. So the first converter circuit 1101 and the second converter circuit 1102 drive the LED array 40 together when the display device is in the 3D mode, which causes brightness of the LED array 40 higher. Upon receiving the first logic notification signal, the microcontroller 115 outputs the 2D micro-control signal to the control circuit 114. Correspondingly, the control circuit 114 outputs the 2D control signal to the second converter circuit 1102. In response to the 2D control signal, the second converter circuit 1102 does not receives the second driving signal, and stops converting the direct current power Vin to the second direct current voltage when the display device is in the 2D mode. The first converter circuit 1101 converts the direct current power Vin into the first direct current voltage according to the first driving signal generated by the first driving circuit 111. In other word, the first converter circuit 1101 drives the LED array 40 alone when the display device is in the 2D mode, which causes brightness of the LED array 40 lower.

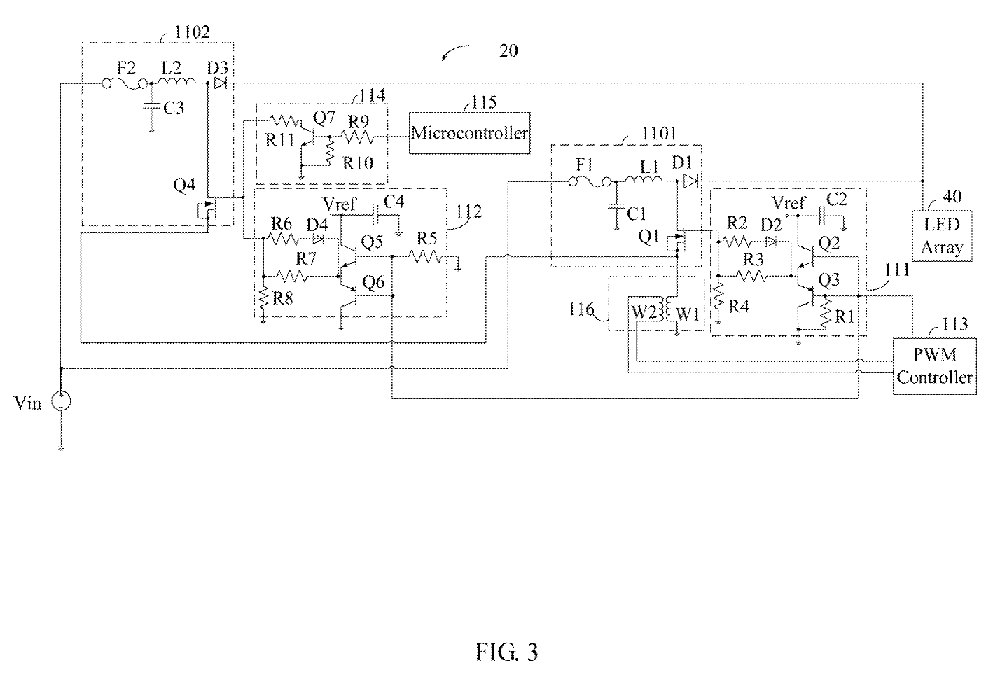

FIG. 3 is a circuit diagram of one embodiment of the LED driving system 20. In the embodiment, the first converter circuit 1101 comprises a first fuse F1, a first inductor L1, a first capacitor C1, a first diode D1 and a first switch Q1. The first fuse F1 is connected to the direct current power Vin, to protect the LED driving system 20 from overcurrent such as when current flowing through the first fuse F1 is too high. The first inductor L1 is connected between the first fuse F1 and an anode of the first diode D1. The first capacitor C1 is connected between a junction of the first fuse F1 and the first inductor L1 and ground. A cathode of the first diode D1 is connected to the anode of the LED array 40. The first switch Q1 has a first pole connected to the anode of the first diode D1, a control pole connected to the first driving circuit 111, and a second pole connected to the current detection element 116.

In the embodiment, the first switch Q1 is a N type metal-oxide semiconductor field effect transistor (NMOSFET). The first pole of the first switch Q1 is a drain of the NMOSFET, the control pole of the first switch Q1 is a gate of the NMOSFET, and the second pole of the first switch Q1 is a source of the NMOSFET.

In the embodiment, the first switch Q1 converts a voltage supplied by the direct current power Vin into a square wave signal according to the first driving signal generated by the first driving circuit 111, and the square wave signal is rectified to be the first direct current voltage by the first diode D1 to drive the LED array 40.

In the embodiment, the first driving circuit 111 comprises a second capacitor C2, a second switch Q2, a third switch Q3, a first resistor R1, a second diode D2, a second resistor R2, a third resistor R3, and a fourth resistor R4. The second capacitor C2 is connected between a reference power Vref and ground. The second switch Q2 has a first pole connected to the reference power Vref, a control pole connected to the PWM controller 113, and a second pole. The third switch Q3 has a first pole connected to the second pole of the second switch Q2, a control pole connected to the control pole of the second switch Q2, and a second pole grounded. The first resistor R1 is connected between the control pole of the third switch Q3 and ground.

In the embodiment, the second switch Q2 is a npn-type transistor. The first pole of the second switch Q2 is a collector of the npn-type transistor, the control pole of the second switch Q2 is a base of the npn-type transistor, and the second pole of the second switch Q2 is an emitter of the npn-type transistor. In the embodiment, the third switch Q3 is a pnp-type transistor. The first pole of the third switch Q3 is an emitter of the pnp-type transistor, the control pole of the third switch Q3 is a base of the pnp-type transistor, and the second pole of the third switch Q3 is a collector of the pnp-type transistor.

In the embodiment, the second switch Q2 is on and the third switch Q3 is off, and then the first driving circuit 111 outputs a high logic first driving signal to the first converter circuit 1101 when the PWM controller 113 outputs a high logic PWM signal. The second switch Q2 is off and the third switch Q3 is on, and then the first driving circuit 111 outputs a low logic first driving signal to the first converter circuit 1101 when the PWM controller 113 outputs a low logic PWM signal.

In the embodiment, the second converter circuit 1102 comprises a second fuse F2, a second inductor L2, a third capacitor C3, a third diode D3 and a fourth switch Q4. The second fuse F2 is connected to the direct current power Vin, to protect the LED driving system 20 when current flowing through the second fuse F2 is too high. The second inductor L2 is connected between the second fuse F2 and an anode of the third diode D3. The third capacitor C3 is connected between a junction of the second fuse F2 and the second inductor L2 and ground. A cathode of the third diode D3 is connected to the anode of the LED array 40. The fourth switch Q4 has a first pole connected to the anode of the third diode D3, a control pole connected to the second converter circuit 112 and the control circuit 114, and a second pole connected to the current detection element 116.

In the embodiment, the fourth switch Q4 is N type metal-oxide semiconductor field effect transistor (NMOSFET). The first pole of the fourth switch Q4 is a drain of the NMOSFET, the control pole of the fourth switch Q4 is a gate of the NMOSFET, and the second pole of the fourth switch Q4 is a source of the NMOSFET.

In the embodiment, working principle of the second converter circuit 1102 is similar to the first converter circuit 1101.

In the embodiment, the second driving circuit 112 comprises a fourth capacitor C4, a fifth resistor R5, a fifth switch Q5, a six switch Q6, a fourth diode D4, a sixth resistor R6, a seventh resistor R7 and an eighth resistor R8. The fourth capacitor C4 is connected between the reference power Vref and ground. The fifth resistor R5 is connected between the PWM controller 113 and ground. The fifth switch Q5 has a first pole connected to the reference power Vref, a control pole connected to the PWM controller 113 and the fifth resistor R5, and a second pole. The sixth switch Q6 has a first pole connected to the second pole of the fifth switch Q5, a control pole connected to the PWM controller 113 and the control pole of the fifth switch Q5, and a second pole grounded. A cathode of the fourth diode D4 is connected to a second pole of the fifth switch Q5. The sixth resistor R6 is connected between an anode of the fourth diode D4 and the control pole of the fourth switch Q4. The seventh resistor R7 is connected between the second pole of the fifth switch Q5 and the control pole of the fourth switch Q4. The eighth resistor R8 is connected between the control pole of the fourth switch Q4 and ground.

In the embodiment, the fifth switch Q5 is a npn-type transistor. The first pole of the fifth switch Q5 is a collector of the npn-type transistor, the control pole of the fifth switch Q5 is a base of the npn-type transistor, and the second pole of the fifth switch Q5 is an emitter of the npn-type transistor. In the embodiment, the sixth switch Q6 is a pnp-type transistor. The first pole of the sixth switch Q6 is an emitter of the pnp-type transistor, the control pole of the sixth switch Q6 is a base of the pnp-type transistor, and the second pole of the sixth switch Q6 is a collector of the pnp-type transistor.

In the embodiment, working principle of the second driving circuit 112 is similar to the first driving circuit 111.

In the embodiment, the control circuit 114 comprises a ninth resistor R9, a tenth resistor R10, a seventh switch Q7 and an eleventh resistor R11. The seventh switch Q7 has a control pole connected to the microcontroller 115 via the ninth resistor R9, a first pole connected to the control pole of the fourth switch Q4 via the eleventh resistor R11, and a second pole grounded. The tenth resistor R10 is connected between the control pole of the seventh switch Q7 and ground.

In the embodiment, the seventh switch Q7 is a npn-type transistor. The first pole of the seventh switch Q7 is a collector of the npn-type transistor, the control pole of the seventh switch Q7 is a base of the npn-type transistor, and the second pole of the seventh switch Q7 is an emitter of the npn-type transistor.

In the embodiment, the microcontroller 115 outputs the 3D micro-control signal to the ninth resistor R9 when the display device is in the 3D mode, so voltage of the base and the emitter of the seventh switch Q7 are equal. Thus, the seventh switch Q7 is off, and voltage of the collector of the seventh switch Q7 is high, such as 5V. In other word, the control circuit 114 outputs the 3D control signal with opposite voltage level to the 3D micro-control signal to the second converter circuit 1102. The microcontroller 115 outputs the 2D micro-control signal to the ninth resistor R9 when the display device 10 is in the 2D mode, so voltage of the base of the seventh switch Q7 is higher than the emitter of the seventh switch Q7. Thus, the seventh switch Q7 is turned on, and voltage of the collector of the seventh switch Q7 is low, such as 0.1V. In other word, the control circuit 114 outputs the 2D control signal with opposite voltage level to the 2D micro-control signal to the second converter circuit 1102.

In the embodiment, the PWM controller 111 is FP3843 microchip comprising an output pin. The control poles of the second switch Q2, the third switch Q3, the fifth switch Q5, the sixth switch Q6 are both connected to the output pin.

In the embodiment, the current detection element 116 comprises a first winding W1 and a second winding W2. The first winding W1 is connected between the first converter circuit 1101 and the second converter circuit 1102 and ground, to detect the total current of the first converter circuit 1101 and the second converter circuit 1102. The second winding W2 is connected to the PWM controller 113, to sense the total current of the first converter circuit 1101 and the second converter circuit 1102 flowing through the first winding W1, and outputs the feedback signal to the PWM controller 113 according to the total current.

In the embodiment, the microcontroller 115 generates the 2D micro-control signal to the ninth resistor R9 when the display device 10 is in the 2D mode, so voltage of the base of the seventh switch Q7 is higher than the emitter of the seventh switch Q7. Thus, the seventh switch Q7 is turned on, and voltage of the collector of the seventh switch Q7 is low, such as 0.1V. In other word, voltage of the gate and the source of the fourth switch Q4 are equal, so the fourth switch Q4 is off, and the second converter circuit 1102 does not receives the second driving signal, and stops working. The first converter circuit 1101 converts the direct current power Vin into the first direct current voltage according to the first driving signal generated by the first driving circuit 111. So the first converter circuit 1101 drives the LED array 40 alone when the display device 10 is in the 2D mode, which causes brightness of the LED array 40 to decrease.

In the embodiment, the microcontroller 115 generates the 3D micro-control signal to the ninth resistor R9 when the display device 10 is in the 3D mode, so voltage of the base and the emitter of the seventh switch Q7 are equal. Thus, the seventh switch Q7 is off, and voltage of the collector seventh switch Q7 is high, such as 5V. In other word, voltage of the gate of the fourth switch Q4 is higher than the source of the fourth switch Q4, so the fourth switch Q4 is turned on, and receives the second driving signal from the second driving circuit 112. Correspondingly, upon receiving the second driving signal from the second driving circuit 112, the second converter circuit 1102 converts the direct current power Vin into the second direct current voltage to drive the LED array 40. The first converter circuit 1101 converts the direct current power Vin into the first direct current voltage according to the first driving signal generated by the first driving circuit 111. So the first driving circuit 111 and the second driving circuit 112 drive the LED array 40 together when the display device 10 is in the 3D mode, which causes brightness of the LED array 40 to increase.

The LED driving system 20 controls the control circuit 114 to output the 3D control signal or the 2D control signal, to control the second converter circuit 1102 whether to work according to the different modes of the display panel 50. Thus, the second converter circuit 1102 is controlled whether to drive the LED array 40 together with the first converter circuit 1101, which satisfies needs of the LED array 40 in the different modes. Thus, the LED driving system 20 is flexible and has a low design complexity.

The foregoing disclosure of the various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A light emitting diode (LED) driving system, to drive an LED array of a display device under control of a panel driver, the LED driving system comprising:
a microcontroller, connected to the panel driver, to output a first signal when the display device is in a three dimension (3D) mode, and to output a second signal when the display device is in a two dimension (2D) mode;
a control circuit, connected to the microcontroller, to output a 3D control signal upon receiving the first signal, and to output a 2D control signal upon receiving the second signal;
a pulse width modulator (PWM) controller, to output PWM signals;
a first driving circuit, connected to the PWM controller to output a first driving signal according to the PWM signals;
a second driving circuit, connected to the PWM controller to output a second driving signal according to the PWM signals;
a first converter circuit, connected to a direct current power and the first driving circuit, to convert the direct current power into a first direct current voltage to drive the LED array according to the first driving signal;
a second converter circuit, connected to the direct current power, the second driving circuit and the control circuit, to convert the direct current power into a second direct current voltage to drive the LED array together with the first direct current voltage according to the second driving signal; and
a current detection element, connected to the first converter circuit, a second converter circuit and the PWM controller, to detect total current of the first converter circuit and the second converter circuit and generate a feedback signal according to the total current, and to output the feedback signal to the PWM controller to adjust duty cycle of the PWM signals;
wherein the second converter circuit converts the direct current power into the second direct current voltage upon receiving the second driving signal when the display device is in the 3D mode, and the second converter circuit stops converting the direct current power into the second direct current voltage upon not receiving the second driving signal when the display device is in the 2D mode.

2. The LED driving system of claim 1, wherein the first converter circuit comprises:
a first fuse, having one end connected to the direct current power;
a first inductor, having one end connected to the other end of the first fuse;
a first capacitor, connected between a junction of the first inductor and the first fuse and ground;
a first diode, having an anode connected to the other end of the first inductor, and a cathode connected to an anode of the LED array; and
a first switch, comprising a first pole connected to the anode of the first diode, a control pole connected to the first driving circuit, and a second pole connected to the current detection element.

3. The LED driving system of claim 2, wherein the first switch is a N type metal-oxide semiconductor field effect transistor (NMOSFET), the first pole of the first switch is a drain of the NMOSFET, the control pole of the first switch is a gate of the NMOSFET, and the second pole of the first switch is a source of the NMOSFET.

4. The LED driving system of claim 2, wherein the first driving circuit comprises:
a second capacitor, connected between reference power and ground;
a second switch, comprising a first pole connected to the reference power, a control pole connected to the PWM controller to receive the PWM signals, and a second pole;
a third switch, comprising a first pole connected to the second pole of the second switch, a control pole connected to the PWM controller together with the control pole of the second switch, and a second pole grounded;
a first resistor, connected between the control pole of the third switch and ground;
a second diode, having a cathode connected to the second pole of the second switch;
a second resistor, connected between an anode of the second diode and the control pole of the first switch;
a third resistor, connected between the second pole of the second switch and the control pole of the first switch; and
a fourth resistor, connected between the control pole of the first switch and ground.

5. The LED driving system of claim 4, wherein the second switch is a npn-type transistor, the first pole of the second switch is a collector of the npn-type transistor, the control pole of the second switch is a base of the npn-type transistor, and the second pole of the second switch is an emitter of the npn-type transistor, the third switch Q3 is a pnp-type transistor, the first pole of the third switch Q3 is an emitter of the pnp-type transistor, the control pole of the third switch Q3 is a base of the pnp-type transistor, and the second pole of the third switch Q3 is a collector of the pnp-type transistor.

6. The LED driving system of claim 1, wherein the second converter circuit comprises:
a second fuse, having one end connected to the direct current power, to protect the LED driving system when current flowing through the second fuse is high;
a second inductor, having one end connected to the other end of the second fuse;
a third capacitor, connected between a junction of the second inductor and the second fuse and ground;
a third diode, having an anode connected to the other end of the second fuse, and a cathode connected to the anode of the LED array; and
a fourth switch, comprising a first pole connected to the anode of the third diode, a second pole connected to the current detection element, and a control pole connected to the control circuit.

7. The LED driving system of claim 6, wherein the second driving circuit comprises:
a fourth capacitor, connected between reference power and ground; a fifth resistor, connected between the PWM controller and ground;
a fifth switch, comprising a first pole connected to the reference power, a control pole connected to the PWM controller together with the fifth resistor, and a second pole;
a sixth switch, comprising a first pole connected to the second pole of the fifth switch, a control pole connected to the PWM controller together with the control pole of the fifth switch to receive the PWM signals, and the second pole grounded;
a fourth diode, having a cathode connected to the second pole of the fifth switch;
a sixth resistor, connected between an anode of the fourth diode and the control pole of the fourth switch;
a seventh resistor, connected between the second pole of the fifth switch and the control pole of the fourth switch; and
an eighth resistor, connected between the control pole of the fourth switch and ground.

8. The LED driving system of claim 7, wherein the control circuit comprises:
a ninth resistor, having one end connected to the microcontroller;
a tenth resistor, connected between the other end of the ninth resistor and ground;
a seventh switch, comprising a first pole, a control pole connected the other end of the ninth resistor, and a second pole grounded; and
an eleventh resistor, connected between the control pole of the fourth switch and the first pole of the seventh switch.

9. The LED driving system of claim 1, wherein the current detection element comprises:
a first winding, connected between a junction of the first converter circuit and the second converter circuit and ground, to detect total current of the first converter circuit and the second converter circuit; and
a second winding, connected to the PWM controller, to sense the total current of the first converter circuit and the second converter circuit, generate a feedback signal according to the total current and output the feedback signal to the PWM controller.

10. A display device, comprising:
a display panel capable of displaying in a two dimension (2D) mode or a three dimension (3D) mode;
a panel driver, to drive the display panel to display video content in the 2D mode or the 3D mode;
a light emitting diode (LED) array;
a current balance system, connected to a cathode of the LED array to balance current flowing through the LED array; and
an LED driving system, to drive the LED array, the LED driving system comprising:
a microcontroller, connected to the panel driver, to output a first signal when the display device is in a three dimension (3D) mode, and to output a second signal when the display device is in a two dimension (2D) mode;
a control circuit, connected to the microcontroller, to output a 3D control signal upon receiving the first signal, and to output a 2D control signal upon receiving the second signal;
a pulse width modulator (PWM) controller, to output PWM signals;
a first driving circuit, connected to the PWM controller to output a first driving signal according to the PWM signals;
a second driving circuit, connected to the PWM controller to output a second driving signal according to the PWM signals;
a first converter circuit, connected to a direct current power and the first driving circuit, to convert the direct current power into a first direct current voltage to drive the LED array according to the first driving signal;
a second converter circuit, connected to the direct current power, the second driving circuit and the control circuit, to convert the direct current power into a second direct current voltage to drive the LED array together with the first direct current voltage according to the second driving signal; and
a current detection element, connected to the first converter circuit, a second converter circuit and the PWM controller, to detect total current of the first converter circuit and the second converter circuit and generate a feedback signal according to the total current, and to output the feedback signal to the PWM controller to adjust duty cycles of the PWM signals;
wherein the second converter circuit converts the direct current power into the second direct current voltage upon receiving the second driving signal when the display device is in the 3D mode, and the second converter circuit stops converting the direct current power to the second direct current voltage upon not receiving the second driving signal when the display device is in the 2D mode.

11. The display device of claim 10, wherein the first converter circuit comprises:
a first fuse, having one end connected to the direct current power;
a first inductor, having one end connected to the other end of the first fuse;
a first capacitor, connected between a junction of the first inductor and the first fuse and ground;
a first diode, having an anode connected to the other end of the first inductor, and a cathode connected to an anode of the LED array; and
a first switch, comprising a first pole connected to the anode of the first diode, a control pole connected to the first driving circuit, and a second pole connected to the current detection element.

12. The display device of claim 11, wherein the first switch is a N type metal-oxide semiconductor field effect transistor (NMOSFET), the first pole of the first switch is a drain of the NMOSFET, the control pole of the first switch is a gate of the NMOSFET, and the second pole of the first switch is a source of the NMOSFET.

13. The display device of claim 11, wherein the first driving circuit comprises:
a second capacitor, connected between reference power and ground;
a second switch, comprising a first pole connected to the reference power, a control pole connected to the PWM controller to receive the PWM signals, and a second pole;
a third switch, comprising a first pole connected to the second pole of the second switch, a control pole connected to the PWM controller together with the control pole of the second switch, and a second pole grounded;
a first resistor, connected between the control pole of the third switch and ground;
a second diode, having a cathode connected to the second pole of the second switch;
a second resistor, connected between an anode of the second diode and the control pole of the first switch;
a third resistor, connected between the second pole of the second switch and the control pole of the first switch; and
a fourth resistor, connected between the control pole of the first switch and ground.

14. The display device of claim 13, wherein the second switch is a npn-type transistor, the first pole of the second switch is a collector of the npn-type transistor, the control pole of the second switch is a base of the npn-type transistor, and the second pole of the second switch is an emitter of the npn-type transistor, the third switch Q3 is a pnp-type transistor, the first pole of the third switch Q3 is an emitter of the pnp-type transistor, the control pole of the third switch Q3 is a base of the pnp-type transistor, and the second pole of the third switch Q3 is a collector of the pnp-type transistor.

15. The display device of claim 10, wherein the second converter circuit comprises:
a second fuse, having one end connected to the direct current power, to protect the LED driving system when current flowing through the second fuse is high;
a second inductor, having one end connected to the other end of the second fuse;
a third capacitor, connected between a junction of the second inductor and the second fuse and ground;
a third diode, having an anode connected to the other end of the second fuse, and a cathode connected to the anode of the LED array; and
a fourth switch, comprising a first pole connected to the anode of the third diode, a second pole connected to the current detection element, and a control pole connected to the control circuit.

16. The display device of claim 15, wherein the second driving circuit comprises:
a fourth capacitor, connected between reference power and ground; a fifth resistor, connected between the PWM controller and ground;
a fifth switch, comprising a first pole connected to the reference power, a control pole connected to the PWM controller together with the fifth resistor, and a second pole;
a sixth switch, comprising a first pole connected to the second pole of the fifth switch, a control pole connected to the PWM controller together with the control pole of the fifth switch to receive the PWM signals, and the second pole grounded;
a fourth diode, having a cathode connected to the second pole of the fifth switch;
a sixth resistor, connected between an anode of the fourth diode and the control pole of the fourth switch;
a seventh resistor, connected between the second pole of the fifth switch and the control pole of the fourth switch; and
an eighth resistor, connected between the control pole of the fourth switch and ground.

17. The display device of claim 16, wherein the control circuit comprises:
a ninth resistor, having one end connected to the microcontroller;
a tenth resistor, connected between the other end of the ninth resistor and ground;
a seventh switch, comprising a first pole, a control pole connected the other end of the ninth resistor, and a second pole grounded; and
an eleventh resistor, connected between the control pole of the fourth switch and the first pole of the seventh switch.

18. The display device of claim 10, wherein the current detection element comprises:
a first winding, connected between a junction of the first converter circuit and the second converter circuit and ground, to detect total current of the first converter circuit and the second converter circuit; and
a second winding, connected to the PWM controller, to sense the total current of the first converter circuit and the second converter circuit, generate a feedback signal according to the total current and output the feedback signal to the PWM controller.

19. A light emitting diode (LED) driving system, to drive an LED array of a display device under control of a panel driver, the LED driving system comprising:
a pulse width modulator (PWM) controller, to output PWM signals;
a first driving circuit, connected to the PWM controller to output a first driving signal according to the PWM signals;
a second driving circuit, connected to the PWM controller to output a second driving signal according to the PWM signals;
a first converter circuit, connected to a direct current power and the first driving circuit, to convert the direct current power into a first direct current voltage to drive the LED array according to the first driving signal;
a second converter circuit, connected to the direct current power and the second driving circuit, to convert the direct current power into a second direct current voltage to drive the LED array together with the first direct current voltage according to the second driving signal;
a control circuit, connected to the second converter circuit to output a 3D control signal to control the second driving signal input to the second converter circuit when the display device is in a three dimension (3D) mode, and to output a 2D control signal to stop the second driving signal inputting to the second converter circuit when the display device is in a two dimension (2D) mode; and
a current detection element, connected to the first converter circuit, a second converter circuit and the PWM controller, to detect total current of the first converter circuit and the second converter circuit and generate a feedback signal according to the total current, and to output the feedback signal to the PWM controller to adjust duty cycles of the PWM signals.
